(19) United States
(12) Patent Application Publication
(10) Pub. No.: US 2022/0058947 A1
(43) Pub. Date: Feb. 24, 2022

(54) INFORMATION PROCESSING DEVICE, VEHICLE, AND INFORMATION PROCESSING METHOD

(71) Applicant: Toyota Jidosha Kabushiki Kaisha, Toyota-shi Aichi-ken (JP)

(72) Inventor: Yuki Nakagawa, Toyokawa-shi Aichi-ken (JP)

(21) Appl. No.: 17/403,028

(22) Filed: Aug. 16, 2021

(30) Foreign Application Priority Data
Aug. 19, 2020 (JP) 2020-138647

(51) Int. Cl. G08G 1/16; G06K 9/00

(52) U.S. Cl. CPC G08G 1/161; G08G 1/166; G06K 9/00805; G06K 9/00362

(57) ABSTRACT

An information processing device includes a controller configured to: receive, from a vehicle that is present in surroundings, information about traveling of the vehicle, acquire, from a sensor that is connected, at least one piece of event information about an event occurring in the surroundings, predict a path of the vehicle based on the information about traveling of the vehicle, select first event information from the at least one piece of event information, based on the path of the vehicle that is predicted, and transmit the first event information.

### CROSS REFERENCE TO THE RELATED APPLICATION

This application claims the benefit of Japanese Patent Application No. 2020-138647, filed on Aug. 19, 2020, which is hereby incorporated by reference herein in its entirety.

### BACKGROUND

### Technical Field

The present disclosure relates to an information processing device, a vehicle, and an information processing method.

### Description of the Related Art

There is disclosed a technique of reducing communication load by dividing information to be transmitted through vehicle-to-vehicle communication into safety information, convenience information, general information, and subject vehicle information, determining a priority ranking of each information piece obtained by dividing, and repeatedly transmitting an information piece with a high priority ranking a greater number of times (for example, Patent document 1).

### CITATION LIST

### Patent Document

[Patent document 1] Japanese Patent Laid-Open No. 2014-59651

However, in a case where a plurality of vehicles is present in the surroundings, each vehicle detects the same event and transmits information about the event, and thus, congestion in communication through vehicle-to-vehicle communication is possibly not solved. Moreover, information that is transmitted through vehicle-to-vehicle communication is not necessarily information that is useful to a vehicle in the surroundings, and when information that is not useful to a vehicle in the surroundings is transmitted through vehicle-to-vehicle communication, congestion in vehicle-to-vehicle communication is possibly not solved.

An aspect of the disclosure is aimed at providing an information processing device, a vehicle, and an information processing method that are capable of alleviating congestion in vehicle-to-vehicle communication.

### SUMMARY

An aspect of the present disclosure is an information processing device comprising a controller configured to:

receive, from a vehicle that is present in surroundings, information about traveling of the vehicle,

acquire, from a sensor that is connected, at least one piece of event information about an event occurring in the surroundings,

predict a path of the vehicle based on the information about traveling of the vehicle,

select first event information from the at least one piece of event information, based on the path of the vehicle that is predicted, and

transmit the first event information that is selected.

Another aspect of the present disclosure is a vehicle on which an information processing device is mounted, the information processing device including a controller configured to:

receive, from a first vehicle that is present in surroundings, information about traveling of the first vehicle,

acquire, from a sensor that is connected, at least one piece of event information about an event occurring in the surroundings,

predict a path of the first vehicle based on the information about traveling of the first vehicle, select first event information from the at least one piece of event information, based on the path of the first vehicle that is predicted, and

transmit the first event information that is selected.

Another aspect of the present disclosure is an information processing method comprising:

receiving, from a vehicle that is present in surroundings, information about traveling of the vehicle,

acquiring, from a sensor that is connected, at least one piece of event information about an event occurring in the surroundings,

predicting a path of the vehicle based on the information about traveling of the vehicle, selecting first event information from the at least one piece of event information, based on the path of the vehicle that is predicted, and

transmitting the first event information that is selected.

According to the present disclosure, congestion in vehicle-to-vehicle communication may be alleviated.

### BRIEF DESCRIPTION OF THE DRAWINGS

FIG. 1 is a diagram illustrating an example configuration of a vehicle-to-vehicle communication system according to a first embodiment;

FIG. 2 is a diagram illustrating an example of a hardware configuration of the vehicle according to the first embodiment;

FIG. 3 is a diagram illustrating an example of a functional configuration of the control device;

FIG. 4 is an example of a flowchart of a transmission process of the risky event information by the control device according to the first embodiment; and

FIG. 5 is a diagram illustrating a specific example of the transmission process of the risky event information of the vehicle.

### DESCRIPTION OF THE EMBODIMENTS

An aspect of the present disclosure is an information processing device. For example, the information processing device is a device that is mounted on a vehicle, such as an on-board device, a data communication device, or an electronic control unit (ECU). The information processing device may alternatively be a road side device. The information processing device includes a controller configured to receive, from a vehicle that is present in surroundings, information about traveling of the vehicle, acquire, from a sensor that is connected, at least one piece of event information about an event occurring in the surroundings, predict a path of the vehicle based on the information about traveling of the vehicle, select first event information from the at least one piece of event information, based on the path of the vehicle that is predicted, and transmit the first event information that is selected.

The information about traveling of a vehicle that is received from the vehicle in the surroundings is information that is acquired by a sensor provided in the vehicle. The information about traveling of a vehicle includes information pieces such as position information, a speed, a direction, a steering angle, a state of a direction indicator, and the like of the vehicle, for example. Additionally, the information about traveling of a vehicle is not limited to those listed above.

The sensor that acquires the event information may be a radar that uses any one of millimeter waves, infrared rays, ultrasonic waves and sonar, light detection and ranging (LIDAR), or a camera, for example. The event information is information indicating presence of an obstacle, for example. An obstacle is a pedestrian, a motorcycle, a bicycle, another vehicle, a fallen object or the like, for example.

According to an aspect of the present disclosure, the first event information that is selected from pieces of event information acquired by the information processing device is transmitted, and thus, the amount of event information that is transmitted from the information processing device may be reduced. Congestion in vehicle-to-vehicle communication may thus be solved.

Furthermore, in an aspect of the present disclosure, the controller may select, as the first event information, from the at least one piece of event information, event information about an event that possibly crosses the path of the vehicle that is predicted. This enables event information about an event that possibly runs into a vehicle in the surroundings, or in other words, event information that is useful to a vehicle in the surroundings, to be transmitted. Furthermore, in this case, the controller may select the first event information based on magnitude of a damage that is predicted to occur in a case where the path of the vehicle that is predicted is crossed. The event information to be transmitted may thus be narrowed down.

In an aspect of the present disclosure, in relation to event information indicating presence of a pedestrian, among the at least one piece of event information, in a case where the vehicle is present within a predetermined distance from the pedestrian, the controller may select the event information indicating presence of the pedestrian as the first event information. The vehicle in the surroundings may thus be informed of presence of the pedestrian, and the possibility of the pedestrian and the vehicle in the surroundings running into each other may be reduced.

In an aspect of the present disclosure, the controller may select, as the first event information, from the at least one piece of event information, event information about an event that is possibly not detected by the vehicle due to a blocking object. An event that is possibly not detected by the vehicle due to a blocking object is an event that is in a blind spot of the vehicle because of the blocking object, for example. That is, in a case where there is a vehicle that is not detecting the event due to a blocking object, event information about the event is preferentially transmitted. Event information that is useful to the vehicle in the surroundings may thus be transmitted.

Furthermore, the controller does not have to transmit event information about an event with respect to which there is no vehicle whose predicted path is possibly crossed, among the at least one piece of event information. The amount of data that is transmitted from the information processing device may thus be reduced.

Moreover, a vehicle on which the information processing device described above is mounted may also be specified as another aspect of the present disclosure.

In the following, an embodiment of the present disclosure will be described with reference to the drawings. The configuration of the embodiment described below is an example, and the present disclosure is not limited to the configuration of the embodiment.

### First Embodiment

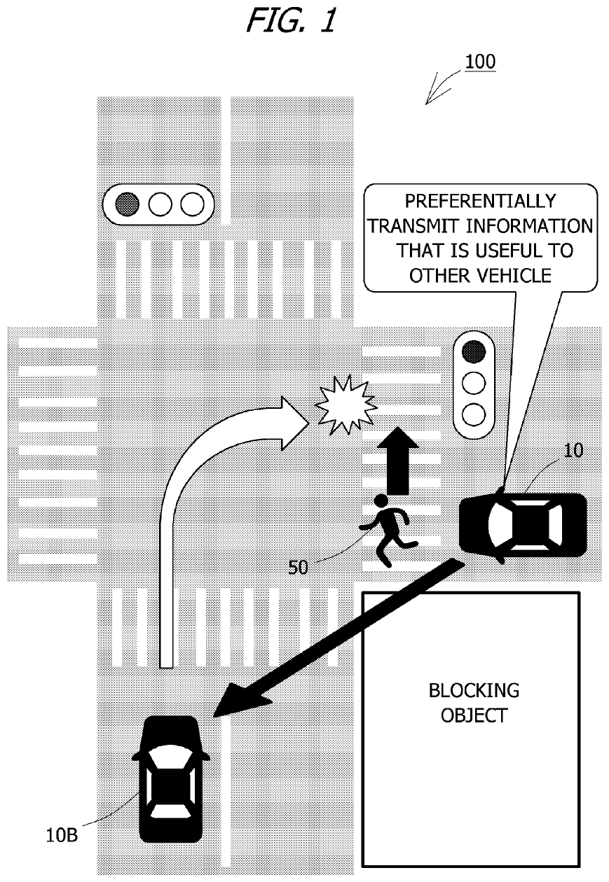

FIG. 1 is a diagram illustrating an example configuration of a vehicle-to-vehicle communication system 100 according to a first embodiment. The vehicle-to-vehicle communication system 100 includes a plurality of vehicles 10 that are capable of vehicle-to-vehicle communication. For example, the vehicle 10 exchanges information with another vehicle 10 using wireless communication such as dedicated short range communication (DSRC), detects an event that is present in the surroundings, and achieves safe driving. FIG. 1 illustrates a vehicle 10 and a vehicle 10B, and both are vehicles capable of vehicle-to-vehicle communication. In the following, in the case of not distinguishing between vehicles that are capable of vehicle-to-vehicle communication, a term “vehicle(s) 10” will be simply used.

For example, information that is exchanged with another vehicle 10 through vehicle-to-vehicle communication includes communicating vehicle information about traveling of the vehicle 10, and risky event information about a risky event that is present in the surroundings, the risky event information being detected by the vehicle 10. For example, the communicating vehicle information includes position information, a speed, a direction, a steering angle, a state of a direction indicator, and the like of the vehicle 10. For example, the communicating vehicle information is transmitted by broadcast every predetermined period. The period of transmitting the communicating vehicle information is set in units of several milliseconds to one second, for example. The communicating vehicle information is an example of “information about traveling of the vehicle”.

A risky event is presence of an object that may become a cause of an accident that involves the vehicle 10, for example. More specifically, a risky event may be presence of an obstacle that is not constantly present at the location, such as a pedestrian, another vehicle, a motorcycle, a bicycle, or a fallen object. Furthermore, a risky event may include an irregular state such as roadworks. A risky event is detected by an obstacle sensor that is mounted on the vehicle 10, for example. When detected, the risky event information is transmitted by broadcast at a timing of transmission of the communicating vehicle information, together with the communicating vehicle information. The vehicles 10 may exchange information about a risky event that each detected by transmitting the risky event information. That is, the risky event information is transmitted to inform a vehicle 10 in the surroundings of a risky event that one detected. The risky event information is an example of “event information”.

Here, the communicating vehicle information is text data, for example, and is information with a relatively small amount of data. On the other hand, the risky event information may be image data including a detected value acquired by the obstacle sensor. In the case where the risky event information is image data, the amount of data is greater compared to that of the communicating vehicle information that is text data. Accordingly, if all the pieces of risky event information detected by each vehicle 10 are transmitted, congestion may possibly occur in vehicle-to-vehicle communication. Moreover, even if the risky event information that is received from the other vehicle 10B is not information that is useful to the subject vehicle 10, the received risky event information is processed, and thus, processing load may be possibly imposed on the vehicle 10. Additionally, the risky event information is not limited to image data.

In the first embodiment, the vehicle 10 preferentially transmits the risky event information that is useful to the vehicle 10B in the surroundings, among the risky event information that is acquired by the obstacle sensor that is mounted on the subject vehicle 10. For example, in FIG. 1, the vehicle 10 detects a pedestrian 50 as a risky event. The vehicle 10 predicts the path of the vehicle 10B based on the communicating vehicle information from the vehicle 10B. In the case where there is a possibility of the pedestrian 50 crossing the path of the vehicle 10B, the vehicle 10 transmits the risky event information indicating presence of the pedestrian 50 preferentially to other risky event information.

The vehicle 10B receives the risky event information indicating presence of the pedestrian 50 through vehicle-to-vehicle communication. In the example illustrated in FIG. 1, the pedestrian 50 is in a blind spot of the vehicle 10B because of a blocking object, and by being notified of presence of the pedestrian 50 by the vehicle 10, the vehicle 10B is enabled to move in such a way as to avoid collision with the pedestrian 50.

For example, the vehicle 10 may reduce a priority ranking of risky event information about a risky event that does not cross a predicted path of the vehicle 10B, and not transmit such risky event information. Accordingly, because information that is not useful to another vehicle is not easily transmitted, the amount of data that is transmitted through vehicle-to-vehicle communication may be reduced.

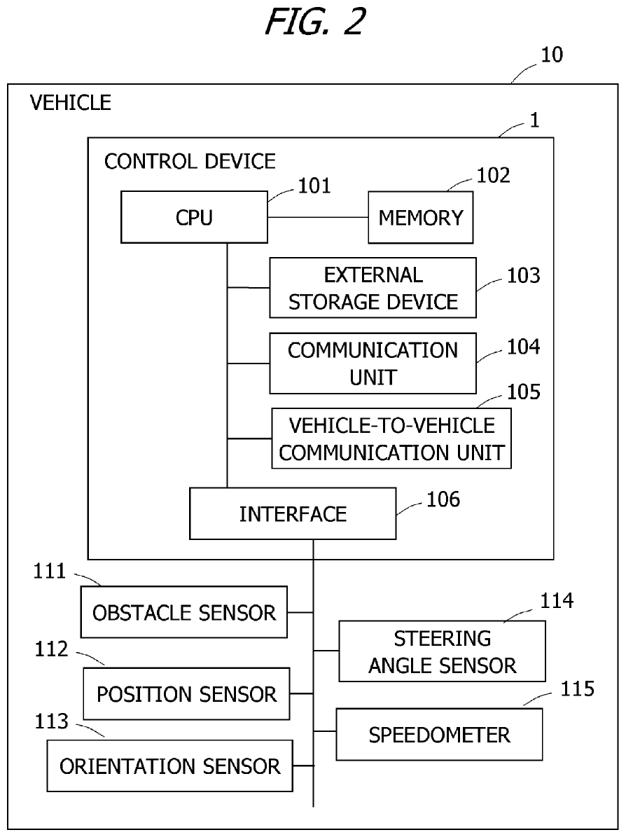

FIG. 2 is a diagram illustrating an example of a hardware configuration of the vehicle 10 according to the first embodiment. For example, the vehicle 10 is a vehicle that travels by being driven by a driver. Additionally, FIG. 2 extracts and illustrates hardware components that are related to processes described in the first embodiment, among hardware components of the vehicle 10. As hardware components, the vehicle 10 includes a control device 1, an obstacle sensor 111, a position sensor 112, an orientation sensor 113, a steering angle sensor 114, and a speedometer 115.

The obstacle sensor 111 is a sensor that detects an obstacle that is present in a detection direction every predetermined period. The obstacle sensor 111 is a radar that uses millimeter waves, ultrasonic waves or infrared rays, a LIDAR, a camera or the like. In the case where the obstacle sensor 111 is a radar, ultrasonic waves, electromagnetic waves or the like are emitted in a detection target direction, and a distribution of reception intensity of reflected waves is acquired as image data. By analyzing the image data based on the reception intensity of the reflected waves, a shape, a size, a position, a relative speed and the like of an obstacle in the detection target direction may be detected, and the type of the obstacle (a pedestrian, a vehicle, a building or the like) may be specified from such information pieces.

In the case where the obstacle sensor 111 is a camera, the camera is an imaging device that uses an image sensor such as a charged-coupled device (CCD), a metal-oxide-semiconductor (MOS) or a complementary metal-oxide-semiconductor (CMOS). The camera acquires an image every predetermined period of time referred to as a frame period. For example, obstacles include pedestrians, bicycles, constructions, fallen objects, buildings and the like. The obstacle sensor 111 may be provided at each of front, rear, left and right of the vehicle 10, for example.

The position sensor 112 is a sensor that acquires the position information of the vehicle 10 every predetermined period. For example, the position sensor 112 is a GPS reception unit. The GPS reception unit receives radio waves carrying time signals from a plurality of satellites (global positioning satellites) orbiting the Earth, and acquires the position information based on the received radio waves. The position information that is acquired by the position sensor 112 is latitude and longitude, for example.

The orientation sensor 113 acquires a direction of the vehicle 10 in the form of orientation every predetermined period. For example, the orientation sensor 113 includes a geomagnetic sensor and a 3-axis accelerometer sensor. The steering angle sensor 114 acquires steering angle information including an angle of a steering wheel. Information about an angle of a traveling direction of the vehicle 10 may be acquired based on the steering angle information, and change of direction of the vehicle 10 may thus be predicted. The speedometer 115 measures a speed of the vehicle 10 every predetermined period.

For example, the control device 1 is an on-board device, a data communication device, a car navigation system, or an ECU. However, the control device 1 is not limited to those listed above. As hardware components, the control device 1 includes a central processing unit (CPU) 101, a memory 102, an external storage device 103, a communication unit 104, a vehicle-to-vehicle communication unit 105, and an interface 106. The memory 102 and the external storage device 103 are each a computer-readable recording medium. The control device 1 is an example of “information processing device”.

The external storage device 103 stores various programs, and data that is used by the CPU 101 at the time of execution of each program. For example, the external storage device 103 is an erasable programmable ROM (EPROM) and/or a hard disk drive. Programs held in the external storage device 103 include an operating system (OS), a vehicle-to-vehicle communication control program, and various other application programs, for example. The vehicle-to-vehicle communication control program is a program for selecting risky event information that is to be preferentially transmitted.

The memory 102 is a main memory that provides the CPU 101 with a storage area where programs that are stored in the external storage device 103 are loaded and a work area, and that is used as a buffer. For example, the memory 102 includes semiconductor memories such as a read only memory (ROM) and a random access memory (RAM).

The CPU 101 performs various processes by loading the OS and various application programs held in the external storage device 103 into the memory 102, and executing the same. There may be a plurality of CPUs 101, without being limited to one. The CPU 101 is an example of “controller” of “information processing device”.

The communication unit 104 is an interface through which information is input/output from a network. For example, the communication unit 104 performs communication by mobile communication methods such as long term evolution (LTE), LTE-Advanced, 5th Generation (5G) and the like or communication via WiFi, and connects to a public network such as the Internet. The vehicle-to-vehicle communication unit 105 performs vehicle-to-vehicle communication with another vehicle. In vehicle-to-vehicle communication, dedicated short range communications (DSRC) are used, for example.

The interface 106 connects hardware structural elements of the vehicle 10, other than the control device 1, to the control device 1. The obstacle sensor 111, the position sensor 112, the orientation sensor 113, the steering angle sensor 114, and the speedometer 115 are connected to the interface 106. Additionally, hardware components of the vehicle 10 illustrated in FIG. 2 are merely examples and are not restrictive. For example, the control device 1 may be connected to a control device that controls direction indicators, and is capable of acquiring lighting states of the direction indicators. The lighting states of the direction indicators include lit and unlit states of lights for left-hand turn and right-hand turn, for example.

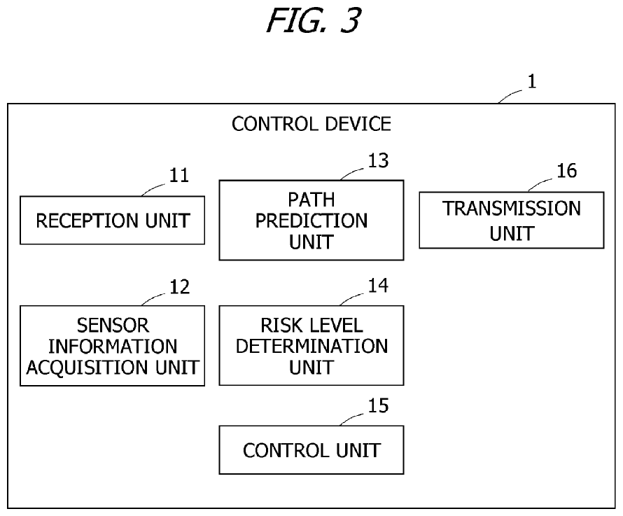

FIG. 3 is a diagram illustrating an example of a functional configuration of the control device 1. As functional structural elements, the control device 1 includes a reception unit 11, a sensor information acquisition unit 12, a path prediction unit 13, a risk level determination unit 14, a control unit 15, and a transmission unit 16. These functional structural elements are implemented by the CPU 101 executing predetermined programs.

The reception unit 11 and the transmission unit 16 are interfaces to a vehicle-to-vehicle communication network. For example, the reception unit 11 receives, through vehicle-to-vehicle communication, the communicating vehicle information and the risky event information transmitted from another vehicle 10. The communicating vehicle information and the risky event information received from another vehicle 10 are output to the control unit 15. For example, the transmission unit 16 transmits, through vehicle-to-vehicle communication, the communicating vehicle information and the risky event information generated by the subject vehicle 10 and input from the control unit 15. Additionally, the communicating vehicle information and the risky event information are transmitted by broadcast or multicast.

The sensor information acquisition unit 12 receives input of detected values from the obstacle sensor 111, the position sensor 112, the orientation sensor 113, the steering angle sensor 114, and the speedometer 115 every predetermined period. The detected value of the obstacle sensor 111 is the image data, for example. The detected value of the position sensor 112 is the position information. The detected value of the orientation sensor 113 is the orientation indicating the direction of the vehicle 10. The detected value of the steering angle sensor 114 is the angle of the steering wheel. The detected value of the speedometer 115 is the speed of the vehicle 10. The sensor information acquisition unit 12 outputs the input detected values of the sensors to the control unit 15.

The control unit 15 controls transmission of information. Specifically, the control unit 15 receives, from the sensor information acquisition unit 12, input of the detected values of the position sensor 112, the orientation sensor 113, the steering angle sensor 114, and the speedometer 115. When a transmission timing of the communicating vehicle information is reached, the control unit 15 generates the communicating vehicle information about the subject vehicle 10 including the detected values of various sensors that are input, and transmits the same through the transmission unit 16. The communicating vehicle information includes the position information, the speed, the direction, the steering angle, the lighting states of the direction indicators, and the like of the vehicle 10, for example.

Furthermore, when input of the communicating vehicle information about another vehicle 10 is received from the reception unit 11, the control unit 15 instructs the path prediction unit 13 to acquire a predicted path of the other vehicle 10, and acquires the predicted path of such other vehicle 10. Next, the control unit 15 instructs the risk level determination unit 14 to determine a level of risk in relation to the risky event information, for example. Additionally, the risky event information that is taken as a target of determination of the level of risk is the risky event information that is acquired after the communicating vehicle information is last transmitted, for example. Additionally, the number of pieces of the risky event information corresponding to the number of the obstacle sensors 111 and to the number of detected obstacles exist.

The control unit 15 performs transmission through the transmission unit 16 preferentially from the risky event information that is selected based on the level of risk. For example, the control unit 15 transmits N pieces of risky event information with the highest levels of risk, in the descending order of the level of risk. Alternatively, the control unit 15 may transmit pieces of risky event information whose levels of risk are at or greater than a predetermined threshold, in the descending order of the level of risk.

The path prediction unit 13 predicts the path of the other vehicle 10 according to an instruction from the control unit 15, and outputs the predicted path to the control unit 15. The path prediction unit 13 receives, from the control unit 15, input of the communicating vehicle information of the other vehicle 10, and acquires the predicted path of the other vehicle 10 from the communicating vehicle information of the other vehicle 10. A method of predicting the path of another vehicle 10 may be any well-known method, and is not limited to a specific method.

The risk level determination unit 14 determines the level of risk of the risky event information according to an instruction from the control unit 15. The risk level determination unit 14 outputs a determination result of the level of risk of the risky event information to the control unit 15. For example, the level of risk may be determined such that the greater the value, the more preferentially the risky event information is transmitted. However, such a case is not restrictive, determination may be performed such that the smaller the value, the more preferentially the risky event information is transmitted.

The level of risk of the risky event information is determined based on the following items, for example.

(Item 1) The risky event possibly crosses the predicted path of the other vehicle 10.
(Item 2) The risky event is a pedestrian, and the other vehicle 10 is present within a predetermined distance from the pedestrian or the other vehicle 10 possibly enters the predetermined distance from the pedestrian.
(Item 3) The risky event will possibly not be perceived by a driver of the other vehicle 10. For example, such a case may be determined when there is a blocking object between the risky event and the other vehicle 10, and the risky event is in the blind spot of the other vehicle 10 because of the blocking object. Additionally, the presence of the blocking object may also be detected by the obstacle sensor 111.
(Item 4) The magnitude of a damage is possibly great in a case where the other vehicle 10 crashes into the risky event. For example, such a case may be determined based on the speed of the other vehicle 10.

For example, the risk level determination unit 14 may acquire the number of matching items among Items 1 to 4 as the level of risk of the risky event information. Alternatively, a weight may be assigned to each item, and a total value of the weights of the matching items may be taken as the level of risk. The weight that is assigned to each item in this case is not limited to a specific value.

Alternatively, points may be calculated for each item, and total points may be taken as the level of risk. For example, in relation to Items 1 to 3, the number of other vehicles 10 that match may be taken as the points of the respective item. Furthermore, in relation to Item 4, the speed of the other vehicle 10 may be converted into points by a predetermined method.

Furthermore, for example, if Item 1 that the risky event possibly crosses the predicted path of the other vehicle 10 is a mandatory condition, the risky event information according to which the predicted path of the other vehicle 10 is not crossed may be determined not to be transmitted.

Additionally, the items for determining the level of risk of the risky event information are not limited to the four listed above. Furthermore, a method of determining the level of risk of the risky event information is not limited to a specific method, and any well-known method may be used. Additionally, at the time of determination of the level of risk of the risky event information, the risky event information received from the other vehicle 10 may be referred to.

<Flow of Processes>

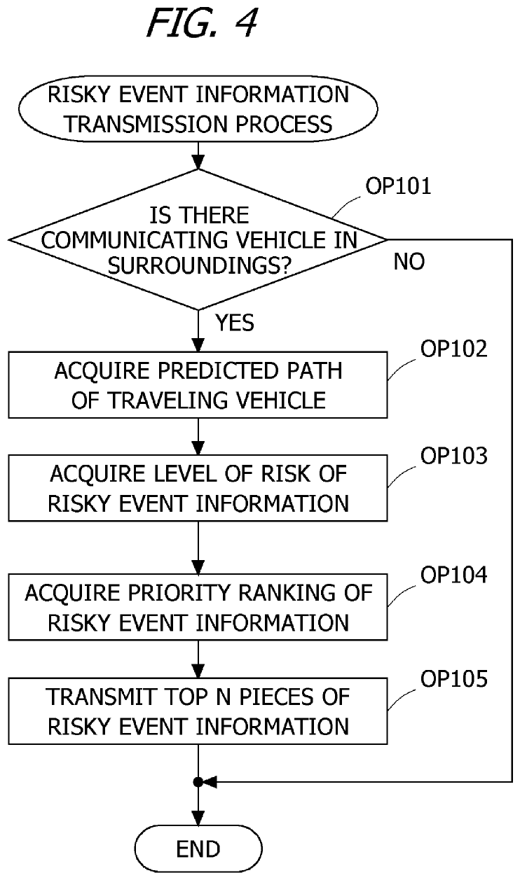

FIG. 4 is an example of a flowchart of a transmission process of the risky event information by the control device 1 according to the first embodiment. The process illustrated in FIG. 4 is repeated every predetermined period. Additionally, the main performer of the process illustrated in FIG. 4 is the CPU 101 of the control device 1, but a description will be given taking a functional structural element as a performer for the sake of convenience.

In OP101, the control unit 15 determines whether or not another vehicle 10 is present in the surroundings. Determination in OP101 is affirmative in a case where the communicating vehicle information about another vehicle 10 is received, and is negative in a case where the communicating vehicle information is not received. In the case where another vehicle 10 is present in the surroundings (OP101: YES), the process proceeds to OP102. In the case where another vehicle 10 is not present in the surroundings (OP101: NO), the process illustrated in FIG. 4 is ended.

In OP102, the control unit 15 instructs the path prediction unit 13 to acquire the predicted path of the other vehicle 10 in the surroundings. In OP103, the control unit 15 instructs the risk level determination unit 14 to acquire the level of risk of each piece of risky event information. In OP104, the control unit 15 acquires the priority rankings of the risky event information based on the levels of risk of the risky event information. For example, the higher the priority ranking is, the greater the value of the level of risk is.

In OP105, at a timing of transmitting the next communicating vehicle information, the control unit 15 transmits, through the transmission unit 16, together with the communicating vehicle information, N pieces of risky event information with the highest priority rankings. The process illustrated in FIG. 4 is then ended. Additionally, risky event information other than the N pieces with the highest priority rankings may be discarded without being transmitted, or may be transmitted when a predetermined condition is satisfied after transmission of the N pieces of risky event information with the highest priority rankings is completed. The condition of transmission of risky event information other than the N pieces with the highest priority rankings is that there are available radio resources or that there is no other transmission data, for example.

Additionally, the transmission process of the risky event information is not limited to the process illustrated in FIG. 4. For example, in OP105, the control unit 15 may transmit risky event information whose level of risk is at or greater than a predetermined threshold.

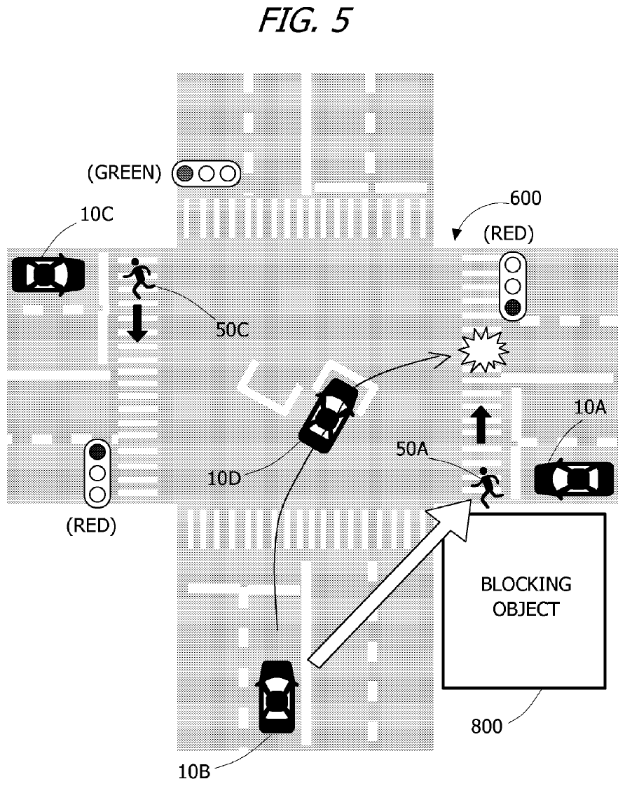

FIG. 5 is a diagram illustrating a specific example of the transmission process of the risky event information of the vehicle 10. A vehicle 10A, a vehicle 10B, a vehicle 10C, and a vehicle 10D in FIG. 5 are each a vehicle that is capable of vehicle-to-vehicle communication and is assumed to be present within a range where vehicle-to-vehicle communication is possible. The vehicles 10A to 10D each transmit the communicating vehicle information every predetermined period.

The transmission process of the risky event information of the vehicle 10A and the vehicle 10B will be described with reference to FIG. 5. The vehicle 10A detects a pedestrian 50A as a risky event. The vehicle 10A detects presence of the vehicle 10B, the vehicle 10C, and the vehicle 10D in the surroundings based on reception of the communicating vehicle information from each vehicle (OP101: YES). The vehicle 10A acquires the predicted path of each of the vehicle 10B, the vehicle 10C, and the vehicle 10D (OP102). The vehicle 10A predicts a right-hand turning path for each of the vehicle 10B and the vehicle 10D, and detects that there is a possibility of the pedestrian 50A crossing the predicted paths. Moreover, because of a blocking object 800, the pedestrian 50A is in a blind spot and is not seen by the driver of the vehicle 10B. Accordingly, the level of risk becomes high for the risky event information indicating presence of the pedestrian 50A (OP103, OP104), and the vehicle 10A transmits the risky event information indicating presence of the pedestrian 50A (OP105).

Next, the vehicle 10C detects a pedestrian 50C as a risky event. The vehicle 10C detects presence of the vehicle 10A, the vehicle 10B, and the vehicle 10D in the surroundings based on reception of the communicating vehicle information from each vehicle (OP101: YES). The vehicle 10C acquires the predicted path of each of the vehicle 10A, the vehicle 10B, and the vehicle 10D (OP102). There is no possibility of the pedestrian 50C crossing the predicted paths of the vehicle 10A, the vehicle 10B, and the vehicle 10D, and moreover, none of the vehicles is present within a predetermined distance from the pedestrian 50C. Accordingly, the level of risk is low for the risky event information indicating presence of the pedestrian 50C (OP103, OP104), and the vehicle 10C transmits other risky event information preferentially to the risky event information indicating presence of the pedestrian 50C, for example.

The risky event information indicating presence of the pedestrian 50C is highly likely not useful to the vehicle 10A, the vehicle 10B, and the vehicle 10D. Accordingly, the priority of transmission of the risky event information indicating presence of the pedestrian 50C is reduced, and radio resources for vehicle-to-vehicle communication may be prevented from being occupied by unnecessary information, and also, processing load may be prevented from being imposed on other vehicles 10.

Additionally, in the example illustrated in FIG. 5, the vehicle 10A also detects the pedestrian 50C, but the level of risk of the risky event information regarding the pedestrian 50C is highly likely to be lowered, and the risky event information regarding the pedestrian 50C is highly likely not preferentially transmitted from the vehicle 10A.

### Operation and Effects of First Embodiment

According to the first embodiment, because the vehicle 10 preferentially transmits risky event information that is useful to another vehicle 10, the amount of data of risky event information that is transmitted by the vehicle 10 at one time may be reduced, and occurrence of congestion in vehicle-to-vehicle communication may be prevented. Furthermore, from the standpoint of another vehicle 10, the number of pieces of risky event information to be received is reduced, and thus, load of processing the received risky event information may be reduced. Furthermore, in the first embodiment, risky event information that is useful to another vehicle 10 is transmitted, and thus, safety of traveling of the vehicles 10 is not impaired.

### OTHER EMBODIMENTS

The embodiment described above is an example, and the present disclosure may be changed and carried out as appropriate without departing from the gist of the present disclosure.

In the first embodiment, the control device 1 mounted on the vehicle 10 detects the risky event, and performs the transmission process of the risky event information described above, but such a case is not restrictive, and the transmission process of the risky event information may alternatively be performed by a road side device, for example. The road side device performs vehicle-to-road communication with the vehicle 10. Like vehicle-to-vehicle communication, vehicle-to-road communication may use DSRC, for example.

In the first embodiment, the vehicle 10 detects a risky event by a sensor that is mounted on the subject vehicle, but such a case is not restrictive, and a risky event may be detected based on information that is received from another vehicle 10, a road side device, or a sensor other than the sensor that is mounted on the subject vehicle, for example.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing device comprising a controller configured to:
receive, from a vehicle that is present in surroundings, information about traveling of the vehicle,
acquire, from a sensor that is connected, at least one piece of event information about an event occurring in the surroundings,
predict a path of the vehicle based on the information about traveling of the vehicle,
select first event information from the at least one piece of event information, based on the path of the vehicle that is predicted, and
transmit the first event information that is selected.

2. The information processing device according to claim 1, wherein the controller is configured to select, as the first event information, from the at least one piece of event information, event information about an event that possibly crosses the path of the vehicle that is predicted.

3. The information processing device according to claim 2, wherein the controller is configured to select the first event information based on magnitude of a damage that is predicted to occur in a case where the path of the vehicle that is predicted is crossed.

4. The information processing device according to claim 1, wherein, in relation to event information indicating presence of a pedestrian, among the at least one piece of event information, in a case where the vehicle is present within a predetermined distance from the pedestrian, the controller is configured to select the event information indicating presence of the pedestrian as the first event information.

5. The information processing device according to claim 1, wherein the controller is configured to select, as the first event information, from the at least one piece of event information, event information about an event that is possibly not detected by the vehicle due to a blocking object.

6. The information processing device according to claim 1, wherein the controller is not configured to transmit event information about an event with respect to which there is no vehicle whose predicted path is possibly crossed, among the at least one piece of event information.

7. The information processing device according to claim 1, wherein
the information processing device is an on-board unit mounted on a first vehicle, and
the controller is configured to
acquire information about traveling of the first vehicle from a sensor mounted on the first vehicle, and
transmit the first event information together with the information about traveling of the first vehicle.

8. A vehicle on which an information processing device is mounted, the information processing device including a controller configured to:
receive, from a first vehicle that is present in surroundings, information about traveling of the first vehicle,
acquire, from a sensor that is connected, at least one piece of event information about an event occurring in the surroundings,
predict a path of the first vehicle based on the information about traveling of the first vehicle,
select first event information from the at least one piece of event information, based on the path of the first vehicle that is predicted, and
transmit the first event information that is selected.

9. The vehicle according to claim 8, wherein the controller is configured to select, as the first event information, from the at least one piece of event information, event information about an event that possibly crosses the path of the first vehicle that is predicted.

10. The vehicle according to claim 9, wherein the controller is configured to select the first event information based on magnitude of a damage that is predicted to occur in a case where the path of the first vehicle that is predicted is crossed.

11. The vehicle according to claim 8, wherein, in relation to event information indicating presence of a pedestrian, among the at least one piece of event information, in a case where the first vehicle is present within a predetermined distance from the pedestrian, the controller is configured to select the event information indicating presence of the pedestrian as the first event information.

12. The vehicle according to claim 8, wherein the controller is configured to select, as the first event information, from the at least one piece of event information, event information about an event that is possibly not detected by the first vehicle due to a blocking object.

13. The vehicle according to claim 8, wherein the controller is not configured to transmit event information about an event with respect to which there is no first vehicle whose predicted path is possibly crossed, among the at least one piece of event information.

14. The vehicle according to claim 8, wherein the controller is configured to acquire information about traveling of the vehicle from a sensor mounted on the vehicle, and
transmit the first event information together with the information about traveling of the vehicle.

15. An information processing method comprising:
receiving, from a vehicle that is present in surroundings, information about traveling of the vehicle,
acquiring, from a sensor that is connected, at least one piece of event information about an event occurring in the surroundings,
predicting a path of the vehicle based on the information about traveling of the vehicle,
selecting first event information from the at least one piece of event information, based on the path of the vehicle that is predicted, and
transmitting the first event information that is selected.

16. The information processing method according to claim 15, wherein event information about an event that possibly crosses the path of the vehicle that is predicted is selected as the first event information, from the at least one piece of event information.

17. The information processing method according to claim 16, wherein the first event information is selected based on magnitude of a damage that is predicted to occur in a case where the path of the vehicle that is predicted is crossed.

18. The information processing method according to claim 15, wherein, in relation to event information indicating presence of a pedestrian, among the at least one piece of event information, in a case where the vehicle is present within a predetermined distance from the pedestrian, the event information indicating presence of the pedestrian is selected as the first event information.

19. The information processing method according to claim 15, wherein event information about an event that is possibly not detected by the vehicle due to a blocking object is selected as the first event information, from the at least one piece of event information.

20. The information processing method according to claim 15, wherein event information about an event with respect to which there is no vehicle whose predicted path is possibly crossed, among the at least one piece of event information, is not transmitted.
